(19) United States
(12) Patent Application Publication
(10) Pub. No.: US 2015/0327101 A1
(43) Pub. Date: Nov. 12, 2015

(54) METHODS, APPARATUS AND COMPUTER PROGRAMS FOR CONTROLLING A USER EQUIPMENT

(71) Applicant: BROADCOM CORPORATION, Irvine, CA (US)

(72) Inventors: Christian HAMILTON, Basingstoke (GB); Kelvin AYRES, Reading (GB)

(73) Assignee: BROADCOM CORPORATION, Irvine, CA (US)

(21) Appl. No.: 14/410,434

(22) PCT Filed: Jun. 18, 2013
(86) PCT No.: PCT/IB2013/054977

§ 371 Date: Dec. 22, 2014

(30) Foreign Application Priority Data
Jun. 20, 2012 (GB) 1210925.2

(51) Int. Cl. H04W 24/10; H04W 76/04

(52) U.S. Cl. CPC H04W 24/10; H04W 76/045

(57) ABSTRACT

A user equipment takes measurements in response to a triggering event (402). The measurements may include measurements relating to maintaining a connection with the network. The measurements may also include measurements directed by a network. The user equipment evaluates its signal conditions (404) and, if it is experiencing unfavourable signal conditions, discards measurements other than those relating to maintaining a connection with the network and prepares a report relating to only those measurements (408).

### CROSS REFERENCE TO RELATED APPLICATION

This application claims the benefit under 35 U.S.C. §119 and 37 CFR §1.55 to UK patent application no. 1210925.2, filed on Jun. 20, 2012, the entire content of which is incorporated herein by reference.

### TECHNICAL FIELD

The present invention relates to methods, apparatus and computer programs for controlling a user equipment. The exemplary and non-limiting embodiments of this invention relate generally to wireless communication. In examples, particular embodiments of the invention relate to reporting by user equipment of signal condition measurements.

### BACKGROUND

Wireless communication systems are continuing to grow in popularity, and demands placed on them by users continue to increase. Many users use their devices constantly, and are annoyed when they experience a weak signal or a delay in transmitting or receiving data. To meet the demands of users, network operators must use their available resources efficiently. Efficient use of resources is particularly important in the case of the radio spectrum available to operators. Network infrastructure, such as base stations, can theoretically be added without limit, with the only constraint being cost, but the currently licensed spectrum is bounded by a theoretical maximum, and the ability to serve users within the bounds imposed by that maximum is governed by an operator's more or less efficient use of the licensed spectrum.

One important mechanism for using the licensed spectrum efficiently is for one or more network elements to alter their behaviour based on conditions being experienced by user devices. In a wireless communication system such as a Third Generation Preferred Partnership Long Term Evolution (3GPP LTE) system, a user device takes measurements relating to network conditions and provides a report of these conditions to its base station. Particularly in unfavourable signal conditions, measurement reports sent to a radio access network (RAN) from a user device, such as a user equipment (UE), can be important to maintaining a communication channel.

### SUMMARY

According to a first aspect of the present invention, there is provided apparatus for controlling a user equipment, the apparatus comprising: a processing system constructed and arranged to cause the apparatus to perform actions comprising: at least evaluating measurements of signal conditions relating to the operation of the user equipment in a wireless communication network to determine if the user equipment is experiencing unfavourable signal conditions; and, if the user equipment is experiencing unfavourable signal conditions, reporting to the network only signal conditions relevant to maintaining a network connection for the user equipment.

According to a second aspect of the present invention, there is provided apparatus for controlling a user equipment, the apparatus comprising: a processing system constructed and arranged to cause the apparatus to perform actions comprising: at least modifying a network parameter according to a scaling factor based at least in part on signal conditions being experienced by the user equipment; and determining a criterion for performing and reporting measurements by the user equipment based on the network parameter as modified by the scaling factor.

According to a third aspect of the present invention, there is provided a computer program comprising instructions for controlling a user equipment, execution of which by a processor configures an apparatus to perform actions comprising at least; evaluating measurements of signal conditions relating to the operation of the user equipment in a wireless communication network to determine if the user equipment is experiencing unfavourable signal conditions; and, if the user equipment is experiencing unfavourable signal conditions, reporting to the network only signal conditions relevant to maintaining a network connection for the user equipment.

According to a fourth aspect of the present invention, there is provided a computer program comprising instructions for controlling a user equipment, execution of which configures an apparatus to perform actions comprising at least: modifying a network parameter according to a scaling factor based at least in part on signal conditions being experienced by the user equipment; and determining a criterion for performing and reporting measurements by the user equipment based on the network parameter as modified by the scaling factor.

According to a fifth aspect of the present invention, there is provided a method of controlling a user equipment, the method comprising: evaluating measurements of signal conditions relating to the operation of a user equipment in a wireless communication network to determine if the user equipment is experiencing unfavourable signal conditions; and if the user equipment is experiencing unfavourable signal conditions, reporting to the network only signal conditions relevant to maintaining a network connection for the user equipment.

According to an sixth aspect of the present invention, there is provided a method of controlling a user equipment, the method comprising: modifying a network parameter according to a scaling factor based at least in part on signal conditions being experienced by the user equipment; and determining a criterion for performing and reporting measurements by the user equipment based on the network parameter as modified by the scaling factor.

The processing systems described above may comprise at least one processor and memory storing computer program code, the memory being configured to, with the at least one processor, cause the apparatus to perform as described above.

There may be provided a computer readable medium storing a program of instructions for controlling a user equipment as described above.

There may be provided a method of controlling a user equipment, the method comprising: configuring at least one processor to cause an apparatus to perform actions as described above.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows schematically an example of a system according to an embodiment of the present invention;

FIG. 2 shows an example of a graph of signal strength versus time;

FIG. 3 shows another example of a graph of signal strength versus time;

FIG. 4 shows schematically an example of a process according to an embodiment of the present invention;

FIG. 5 shows schematically additional details of elements of examples of an embodiment of the present invention.

### DETAILED DESCRIPTION

Examples of embodiments of the present invention recognise that particularly in unfavourable signal conditions, the speed with which a measurement report is transmitted from a user equipment (UE) to a base station, such as an eNodeB (eNB), is important in providing a radio access network (RAN) with the information it needs to accommodate the UE. In many communication systems, a measurement report may be segmented into multiple parts in order to transmit the report to a radio access network. Typically, each segment of a multiple segment transmission requires overhead signalling as well as some delay between segments. Also, naturally, transmission of a longer message requires more time than transmission of a shorter message.

Examples of embodiments of the present invention further recognise that faster transmission of a report leads to faster action in response to the report. Examples of embodiments of the invention further recognise that in unfavourable signal conditions, when adapting to the signal conditions experienced by the UE is more important, faster response to changing conditions affecting the UE is particular valuable. Shortening the report to be transmitted is one particularly convenient way of achieving faster transmission because reducing the amount of data to be transmitted naturally reduces the transmission time. Therefore, upon detection of unfavourable signal conditions, a UE according to one or more embodiments of the present invention limits the number of elements within the report, as compared to a report transmitted in more favourable signal conditions. Such reduction of the size of the report leads to faster transmission to and reception by a radio access network. Therefore, one or more examples of embodiments of the present invention provide for mechanisms to determine when signal conditions are unfavourable for a device and to reduce the size of a measurement report to be transmitted by the device, suitably by excluding from the report categories of measurements that would normally be included if the report were transmitted under normal conditions.

Examples of embodiments of the present invention further recognise that the connection between an eNB and a UE may be more sensitive to conditions and to changes in conditions when the conditions are unfavourable than when they are favourable. Therefore, one or more examples of embodiments of the present invention provide for computing an increased frequency for taking measurements and making measurement reports. Such computation suitably comprises computing a factor based on a comparison between the prevailing conditions and normal conditions.

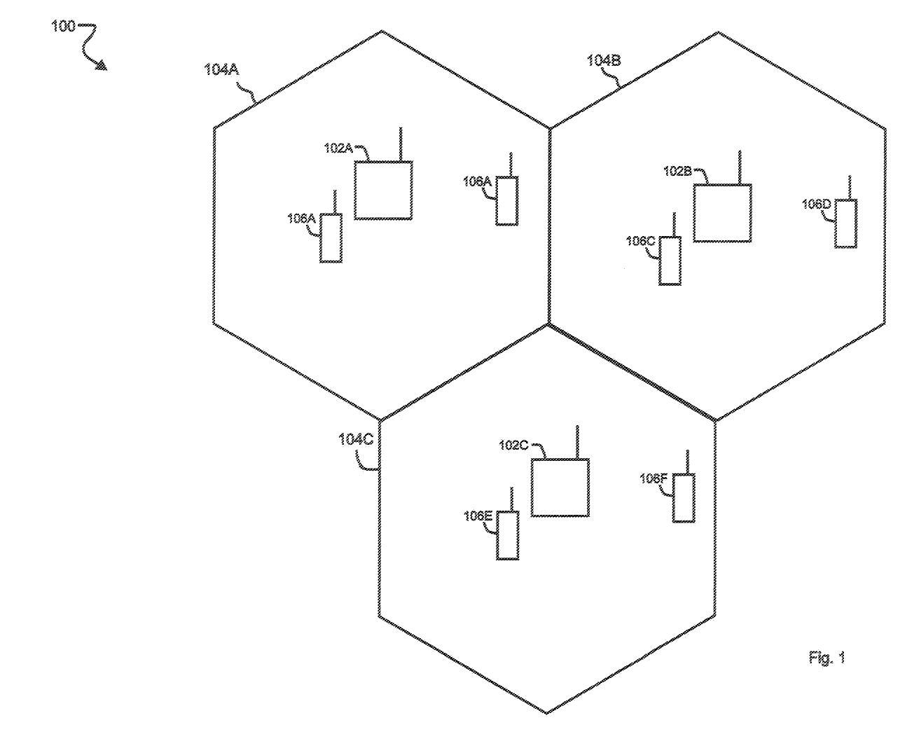

FIG. 1 shows schematically an example of a wireless communication system 100 according to an embodiment of the present invention. The system 100 comprises a plurality of base stations, which may be implemented as eNodeBs (eNBs) 102A-102C. The eNBs 102A-102C define cells 104A-104C. The cells 104A-104C serve a plurality of user devices, here implemented as user equipment (UEs) 106A-106E. The eNBs 102A-102C may communication with a network controller 108, which manages the operation of the eNBs 102A-102C, and which may take into account reports of network conditions transmitted by the UEs 106A-106E.

Only a limited number of eNBs and cells, serving a limited number of UEs, are illustrated in FIG. 1 and discussed here for simplicity of description and illustration, but it will be recognised that a typical network implementation may comprise many eNBs and UEs, with many different types of eNBs and UEs being used. In addition, other radio sources that do not belong to a network such as the network 100 may be present and may affect the signal conditions experienced by the UEs.

In order to help the network controller 108 to manage the operation of the eNBs 102A-102C, the UEs 106A-106E report the signal conditions they are experiencing. During normal conditions, a UE reports both information relating to maintaining its radio communications channel and additional information requested by a network. For example, a network may request information relating to cells that are part of an active set. These are cells that provide downlink physical channels for radio communication and cells that are monitored for cell signal levels. In normal conditions, a UE can afford the time needed for transmission of a report including such information, and the information benefits the overall operation of the network.

However, if the UE is experiencing unfavourable signal conditions, it needs to deliver measurement reports relating to its own channel, and to have the network react to the reports, as quickly as possible in order to preserve the channel. Unfavourable signal conditions may include conditions tending to cause loss of service, such as call drops, excessive numbers of errors, or slow transmission. One mechanism for determining that unfavourable signal conditions are present is to evaluate the signal chip power (Ec/No, i.e. the received energy per chip divided by the power density in the band). The evaluation may, if desired, be performed in terms of the minimum required quality level in the cell (Qqualmin). For example, unfavourable conditions may be determined to exist when the measured Ec/No is less than Qqualmin/2. One suitable value for Qqualmin is −18 dB, so that in such a case, unfavourable signal conditions may be determined to exist when the value of Ec/No is less than −9 dB. Suppose, then, that the UE 106A is experiencing unfavourable signal conditions. The UE 106A may take measurements for all requested cells, but may discard information from its measurement report that is not immediately relevant to maintaining the channel currently being used. In addition, cells for which measurements are below specified thresholds for particular characteristics, such as signal strength, may be discarded from information to be reported. Discarding of particular categories of measurement reports naturally reduces the measurement report size, because the report includes less information to be transmitted. Fewer protocol data units (PDUs) are needed for transmission of a smaller report, leading to a shorter transmission time and a lower likelihood of delay resulting from a need to retransmit unsuccessfully transmitted PDUs.

Measurements may be taken and a report constructed and transmitted when the UE 106A experiences an event associated with a primary scrambling code (PSC). The PSC associated with the event may be relevant to maintaining the channel being used by the UE 106A, and in addition the network may request additional measurements. In one or more embodiments of the invention, a UE such as the UE 106A determines whether or not it is experiencing unfavourable signal conditions. The UE 106A then takes the specified measurements but then reports only the measurements associated with the event. In one example, the UE 106A experiences an event 1A associated with the PSC 179. The UE 106A performs measurements for the PSC 179, and also performs measurements for PSCs 42, 167, 161, 172, 52, and 48. The UE 106A constructs the following report, which occupies 62 bytes after encoding:

```
UL-DCCH-MESSAGE : {
  INTEGRITYCHECKINFO {
  MESSAGEAUTHENTICATIONCODE
  ‘01100001100101010000111001000000’B,
  RRC-MESSAGESEQUENCENUMBER 13
  },
  MESSAGE MEASUREMENTREPORT : {
```

MEASUREMENTIDENTITY 1,
MEASUREDRESULTS INTRAFREQMEASUREDRESULTSLIST
: {

```
{
  CELLSYNCHRONISATIONINFO {
  MODESPECIFICINFO FDD : {
```

COUNTC-SFN-FRAME-DIFFERENCE {

COUNTC-SFN-HIGH 8,
OFF 29

```
  },
  TM 5891
}
```

```
  },
  MODESPECIFICINFO FDD : {
```

PRIMARYCPICH-INFO {
PRIMARYSCRAMBLINGCODE 42
},
CPICH-EC-N0 20,
CPICH-RSCP 15

```
  }
},
{
  CELLSYNCHRONISATIONINFO {
  MODESPECIFICINFO FDD : {
```

COUNTC-SFN-FRAME-DIFFERENCE {

COUNTC-SFN-HIGH 13,
OFF 133

```
  },
  TM 11174
}
```

```
  },
  MODESPECIFICINFO FDD : {
```

PRIMARYCPICH-INFO {
PRIMARYSCRAMBLINGCODE 179
},
CPICH-EC-N0 16,
CPICH-RSCP 13

```
  }
},
{
  CELLSYNCHRONISATIONINFO {
  MODESPECIFICINFO FDD : {
```

COUNTC-SFN-FRAME-DIFFERENCE {

COUNTC-SFN-HIGH 1,
OFF 232

```
  },
  TM 21202
}
```

```
  },
  MODESPECIFICINFO FDD : {
```

PRIMARYCPICH-INFO {
PRIMARYSCRAMBLINGCODE 167
},
CPICH-EC-N0 11,
CPICH-RSCP 10

```
  }
},
{
  CELLSYNCHRONISATIONINFO {
  MODESPECIFICINFO FDD : {
```

COUNTC-SFN-FRAME-DIFFERENCE {

COUNTC-SFN-HIGH 1,
OFF 232

```
  },
  TM 20432
}
```

```
  },
  MODESPECIFICINFO FDD : {
```

PRIMARYCPICH-INFO {
PRIMARYSCRAMBLINGCODE 161
},
CPICH-EC-N0 6,
CPICH-RSCP 8

```
  }
},
{
  CELLSYNCHRONISATIONINFO {
  MODESPECIFICINFO FDD : {
```

COUNTC-SFN-FRAME-DIFFERENCE {

COUNTC-SFN-HIGH 13,
OFF 124

```
  },
  TM 21402
}
```

```
  },
  MODESPECIFICINFO FDD : {
```

PRIMARYCPICH-INFO {
PRIMARYSCRAMBLINGCODE 172
},
CPICH-EC-N0 5,
CPICH-RSCP 8

```
  }
},
{
  CELLSYNCHRONISATIONINFO {
  MODESPECIFICINFO FDD : {
```

COUNTC-SFN-FRAME-DIFFERENCE {

COUNTC-SFN-HIGH 10,
OFF 100

```
  },
  TM 26595
}
```

```
  },
  MODESPECIFICINFO FDD : {
```

PRIMARYCPICH-INFO {
PRIMARYSCRAMBLINGCODE 52
},
CPICH-EC-N0 0,
CPICH-RSCP 4

```
  }
},
{
  CELLSYNCHRONISATIONINFO {
  MODESPECIFICINFO FDD : {
```

COUNTC-SFN-FRAME-DIFFERENCE {

COUNTC-SFN-HIGH 8,
OFF 29

```
  },
  TM 4354
}
```

```
  },
  MODESPECIFICINFO FDD : {
```

PRIMARYCPICH-INFO {
PRIMARYSCRAMBLINGCODE 48
},
CPICH-EC-N0 0,
CPICH-RSCP 4

}
}

},
EVENTRESULTS INTRAFREQEVENTRESULTS : {

EVENTID E1A,
CELLMEASUREMENTEVENTRESULTS FDD : {

{
PRIMARYSCRAMBLINGCODE 179

```
  }
  }
```

}

}
}

However, as noted above, in the present example the UE 106A has determined that it is experiencing unfavourable signal conditions. Therefore, the UE 106A discards the portions of the report that are not relevant to the event associated with the PSC 179.

```
UL-DCCH-MESSAGE : {
  INTEGRITYCHECKINFO {
  MESSAGEAUTHENTICATIONCODE
  ‘01100001100101010000111001000000’B,
  RRC-MESSAGESEQUENCENUMBER 13
  },
  MESSAGE MEASUREMENTREPORT : {
```

MEASUREMENTIDENTITY 1,
MEASUREDRESULTS INTRAFREQMEASUREDRESULTSLIST
: {

```
  {
CELLSYNCHRONISATIONINFO {
  MODESPECIFICINFO FDD : {
```

```
COUNTC-SFN-FRAME-DIFFERENCE {
  COUNTC-SFN-HIGH 8,
  OFF 29
},
TM 5891
```

```
  }
},
MODESPECIFICINFO FDD : {
  PRIMARYCPICH-INFO {
```

PRIMARYSCRAMBLINGCODE 42

```
  },
  CPICH-EC-N0 20,
  CPICH-RSCP 15
  }
```

```
  },
  {
```

CELLSYNCHRONISATIONINFO {
MODESPECIFICINFO FDD : {

```
COUNTC-SFN-FRAME-DIFFERENCE {
  COUNTC-SFN-HIGH 13,
  OFF 133
},
TM 11174
```

```
  }
},
MODESPECIFICINFO FDD : {
  PRIMARYCPICH-INFO {
```

PRIMARYSCRAMBLINGCODE 179

```
  },
  CPICH-EC-N0 16,
  CPICH-RSCP 13
  }
```

```
  },
EVENTRESULTS INTRAFREQEVENTRESULTS : {
  EVENTID E1A,
  CELLMEASUREMENTEVENTRESULTS FDD : {
```

```
  {
  PRIMARYSCRAMBLINGCODE 179
  }
}
```

}

}
}

This report, after encoding, occupies 40 bytes, a saving of 22 bytes as compared to the more detailed report above. This is a saving of over ⅓, allowing for faster transmission with fewer opportunities for transmission failures and need for retransmissions.

In addition to providing for a shortened, and therefore more quickly delivered, report, one or more embodiments of the present invention provide for an increase in the frequency of events that trigger measurements. The UE may compute a scaling factor based on its own measurements, and use the scaling factor to modify network-provided parameters indicating the rate at which triggering events occur. The UE may for example use a network-configured measurement parameter for a measurement event, such as the RSCP/EcNo of serving cells where RSCP is the received signal code power, to compute the scaling factor. Such an approach increases the rate of measurement event triggering in unfavourable conditions and tends to prevent erroneous triggering of neighbour candidate cells in unfavourable conditions.

Suppose that the measured quantity MQ, defined by network parameter configuration, is RSCP or EcNo. A minimum measurement value MMV is defined as the value of the MQ at which a calculated scaling factor CSF tends to zero. A network configured parameter value NCPV is a network configured value such as TTT (time-to-trigger), reporting range, or hysteresis. This may be the normal value used by the network for measurement event triggering.

The UE 106A may compute a calculated scaling factor (CSF). The computation may be, for example, CSF=1-MQ/MMV, or ABS(MQ/MMV).

The scaling factor may, for example, adjust a network parameter so as to increase reporting frequency. Suppose that the network transmitted TTT is 200 ms for event configuration. This is the normal event trigger. The measured quantity is the CPICH (Common Pilot Channel) EcNo, and, at the UE, this value is −9 dB in this example. The minimum measurement value is −20 dB, so that CSF=1−(−1/−20)=0.55. CMP=0.55*200, or 110 ms, so that the UE employs a TTT value of 110 ms rather than 200 ms.

To take another example, the scaling factor may, for example, adjust a network parameter so as to reduce a reporting range, decreasing the likelihood that weaker neighbour cells will cause triggering of a measurement event.

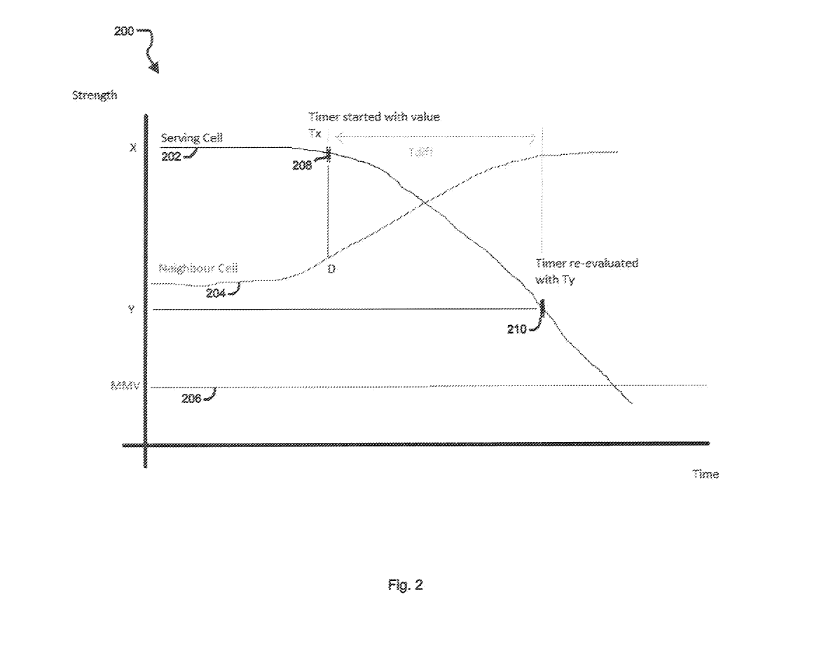

In one example, a scaling factor is used to perform adjustment of a previously started timer, based on a decline of the signal strength that a UE, for example, experiences at its serving cell. FIG. 2 illustrates a graph 200 showing curves 202 and 204, with the curve 202 plotting signal strength against time for a serving cell and the curve 204 plotting signal strength against time for a neighbour cell. A level curve 206 plots the unchanging minimum measurement value against time.

Suppose that at the point 208, an event timer is started with a value of Tₓ, with a UE experiencing a signal strength of X from its serving cell. Tₓ is calculated as CSFₓ*NCPVₜₜₜ, where CSFₓ=(1−(x/MMV)). When the signal strength declines to y, at the point 210, the scaling factor changes to CSF_{y}, where CSF_{y}=(1−y/MMV). The timer value is calculated as T_{y}=CSFₓ*NCPVₜₜₜ. The remaining time at the time of the modification is Tₓ−T_{diff} and the timer is modified by Tₓ−T_{y}. If the remaining time is less than (Tₓ−T_{y}), the timer immediately expires and a triggering event occurs. Even if the timer does not immediately expire, the remaining time is reduced.

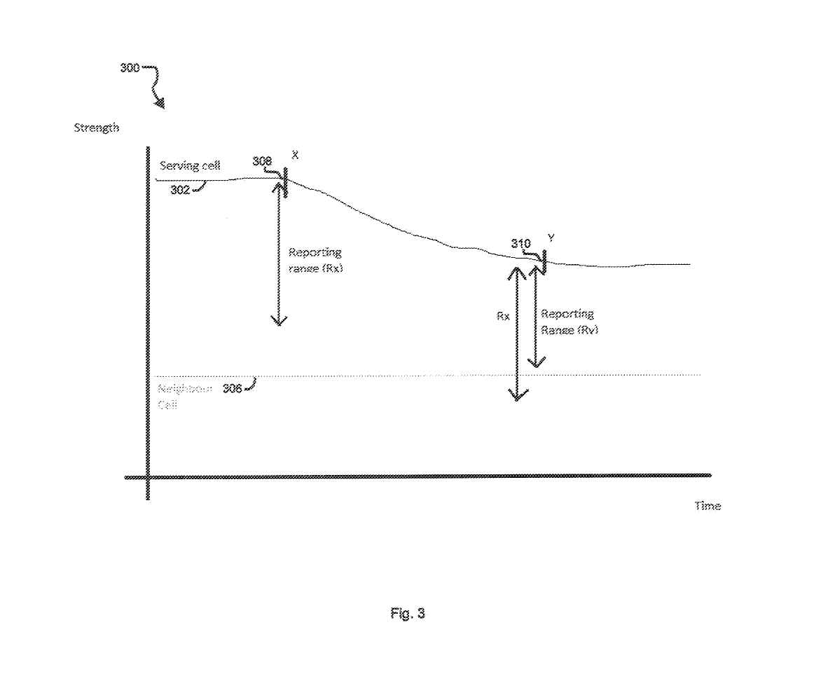

In another example, a lower signal strength of the serving cell reduces a reporting range. FIG. 3 illustrates a graph 300 showing strength versus time curves 302 and 304 for a serving cell and a neighbour cell, respectively. A level strength curve 306 for a neighbour cell is also shown. At point 308, a UE is configured with a reporting range Rₓ. At point 310, the use of the reporting range Rₓ would cause triggering based on the strength of the neighbour cell. Adjustments made according to one or more embodiments of the present invention adjust the reporting range by using a scaling factor CSF_{y}. CSF_{y}=(1−y/MMV), and a reporting range R_{y} is used, with R_{y}=Rₓ*CSF_{y}. If the signal strength experienced by the UE increases, the reporting range can be increased by using the CSF value ABS(MQ/MMV) to adjust the reporting range.

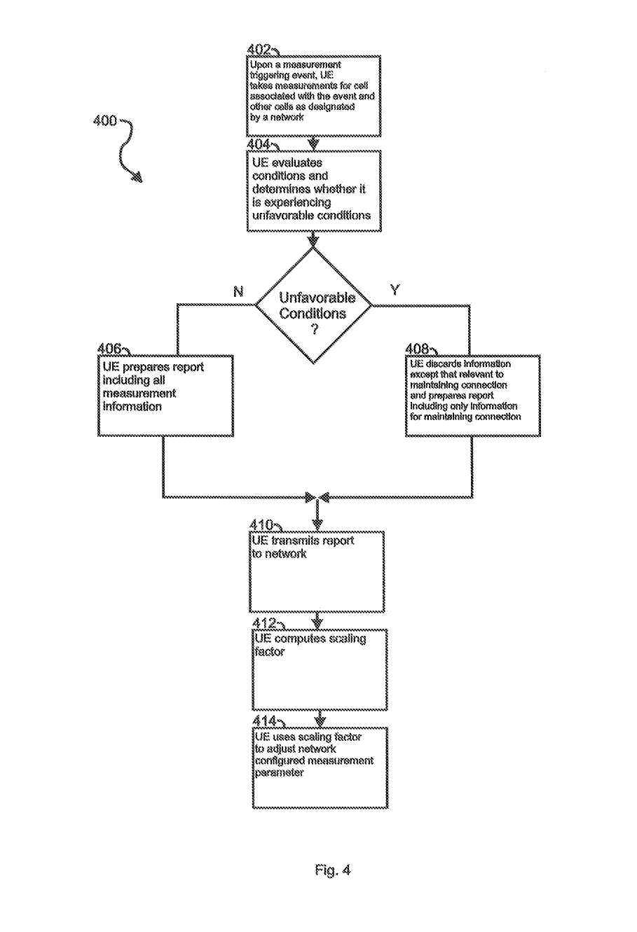

FIG. 4 illustrates an example of a process 400 according to an embodiment of the present invention. At step 402, upon a measurement triggering event, a UE takes measurements for the cell associated with the event, and may also take measurements of other cells as designated by a network. At step 404, the UE evaluates its measurements and determines whether it is experiencing unfavourable signal conditions. If the UE is experiencing normal signal conditions, the process proceeds to step 406 and the UE prepares a report for transmission to the network, such as to its serving base station, including the measurement information. If the UE is experiencing unfavourable signal conditions, the process proceeds to step 408 and the UE discards measurement information other than that needed to maintain its connection and prepares a report for transmission to the network, with the report including only information relevant to maintaining the connection. Either way, tt step 410, the UE transmits the report to the network. At step 412, the UE computes a scaling factor based on its measurements. In at least one embodiment of the invention, the scaling factor will tend to increase the frequency of triggering events if the UE is experiencing unfavourable signal conditions. In one or more additional or alternative embodiments of the invention, the scaling factor will tend to exclude cells. At step 414, the UE uses the scaling factor to adjust a network configured measurement parameter used to determine parameters of a measurement event. The parameters may, for example, relate to the frequency at which a measurement event is triggered. Alternatively or in addition, the parameters may relate to a reporting range for event triggering, for example increasing the strength of a neighbour cell that is required to trigger event reporting, so that a weaker neighbour cell will be less likely to trigger reporting.

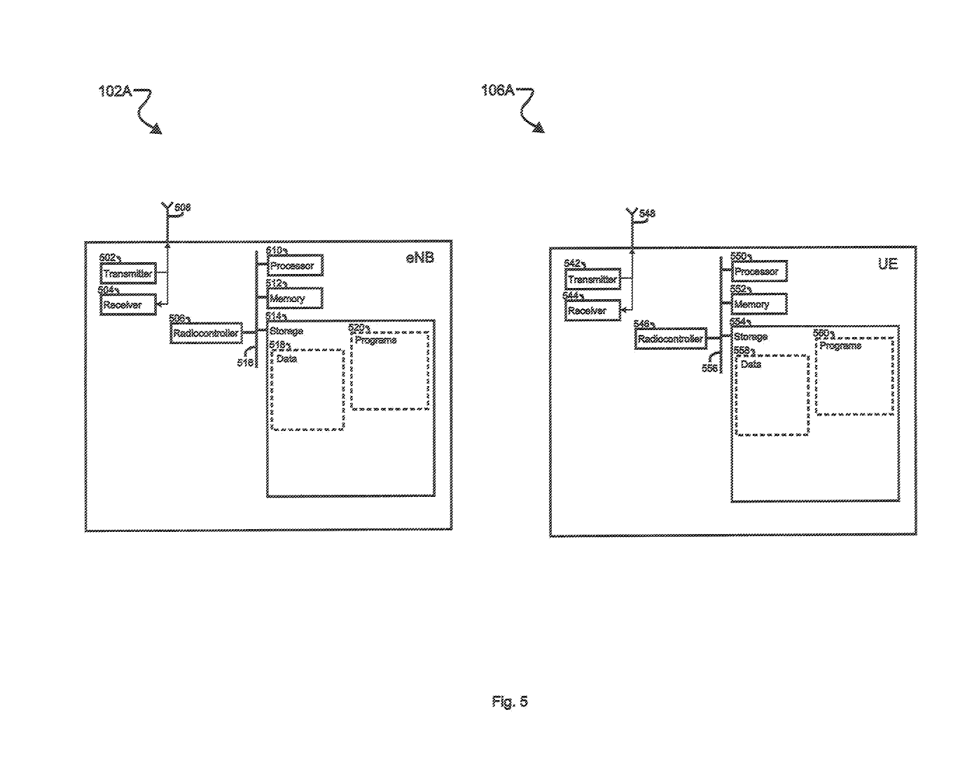

FIG. 5 illustrates further details of examples of the eNB 102A and the UE 106A according to one or more embodiments of the present invention. The eNB 102A may comprise a transmitter 502, receiver 504, radio controller 506, and antenna 508. The eNB 102A may further comprise a processor 510, memory 512, and storage 514, communicating with one another and with the radio controller 506 over a bus 516. The eNB 102A may further comprise data 518 and programs 520, suitably residing in storage 514 and transferred to memory 512 as needed for use by the processor 510.

The UE 106A may comprise a transmitter 542, receiver 544, radio controller 546, and antenna 548. The UE 106A may further comprise a processor 550, memory 552, and storage 554, communicating with one another and with the radio controller 546 over a bus 556. The UE 106A may further comprise data 558 and programs 560, suitably residing in storage 554 and transferred to memory 552 as needed for use by the processor 550.

At least one of the programs 520 in storage 514 of the eNB 102A includes a set of program instructions that, when executed by the processor 510, enable the device to operate in accordance with the exemplary embodiments of this invention, as detailed above, and the UE 106A similarly has software 560 stored in its storage 554. In these regards the exemplary embodiments of this invention may be implemented at least in part by computer software stored in storage 514 or memory 512 which is executable by the processor 510 of the macro eNB 102, or by computer software stored in storage 554 or memory 552 executable by the processor 550 of the UE 106A, or by hardware, or by a combination of tangibly stored software and hardware (and tangibly stored firmware). Electronic devices implementing these aspects of the invention need not be the entire devices as depicted at FIG. 5, or may be one or more components of same such as the above described tangibly stored software, hardware, firmware and DP, or a system-on-a-chip SOC or an application specific integrated circuit ASIC.

In general, the various embodiments of the UE 106A can include, but are not limited to, personal portable digital devices having wireless communication capabilities, including but not limited to cellular telephones, navigation devices, laptop/palmtop/tablet computers, digital cameras and music devices, and Internet appliances, as well as machine-to-machine type devices.

Various embodiments of the computer-readable memories 512 and 552 and storage 514 and 554 include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the processors 510 and 550 include but are not limited to general purpose computers, special purpose computers, microprocessors, digital signal processors (DSPs) and multi-core processors.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An apparatus for controlling a user equipment, the apparatus comprising:
a processing system constructed and arranged to cause the apparatus to perform actions comprising at least:
evaluating measurements of signal conditions relating to the operation of a user equipment in a wireless communication network to determine if the user equipment is experiencing unfavourable signal conditions; and
if the user equipment is experiencing unfavourable signal conditions, reporting to the network only signal conditions relevant to maintaining a network connection for the user equipment.

2. The apparatus according to claim 1, wherein evaluating measurements of signal conditions comprises comparing measurements of signal conditions against values associated with loss of service.

3. The apparatus according to claim 2, wherein comparing measurements of signal conditions against values associated with loss of service comprises comparing at least one value against a minimum required quality level in a cell.

4. The apparatus according to claim 3, wherein comparing the at least one value against the minimum required quality level in the cell comprises comparing signal chip power against the minimum required quality level in the cell, and determining that the user equipment is experiencing unfavourable signal conditions if the value of Ec/No is less than Qqualmin/2.

5. The apparatus according to claim 1, wherein the measurements comprise measurements relating to the network connection for the user equipment and measurements relating to other signal conditions relating to the operation of the network.

6. The apparatus according to claim 5, wherein the measurements relating to the other signal conditions are measurements specified by instructions received from the network.

7. The apparatus according to claim 5, wherein reporting to the network only measurements relating to signal conditions relevant to maintaining the network connection comprises discarding other measurements before assembling the report.

8. The apparatus according to claim 1, wherein evaluating the measurements of signal conditions follows a triggering event causing the user equipment to take measurements, and wherein the signal conditions relevant to maintaining the network connection are associated with the triggering event.

9. The apparatus according to claim 8, wherein the triggering event is associated with a primary scrambling code.

10. The apparatus according to claim 9, wherein reporting to the network comprises discarding measurements not relating to the primary scrambling code associated with the triggering event.

11. An apparatus for controlling a user equipment, the apparatus comprising:
a processing system constructed and arranged to cause the apparatus to perform actions comprising at least:
modifying a network parameter according to a scaling factor based at least in part on signal conditions being experienced by the user equipment; and
determining a criterion for performing and reporting measurements by the user equipment based on the network parameter as modified by the scaling factor.

12. The apparatus according to claim 11, wherein the scaling factor is computed based on a relationship between a measured quantity and a minimum measurement value.

13. The apparatus according to claim 11, wherein the criterion for performing and reporting measurements relates to timing between measurements.

14. The apparatus according to claim 11, wherein the criterion for performing and reporting measurements relates to a reporting range.

15. A non-transitory computer program comprising instructions for controlling a user equipment, execution of which by a processor configures an apparatus to perform actions comprising at least:
evaluating measurements of signal conditions relating to the operation of a user equipment in a wireless communication network to determine if the user equipment is experiencing unfavourable signal conditions; and
if the user equipment is experiencing unfavourable signal conditions, reporting to the network only signal conditions relevant to maintaining a network connection for the user equipment.

16-28. (canceled)

29. A method of controlling a user equipment, the method comprising:
evaluating measurements of signal conditions relating to the operation of a user equipment in a wireless communication network to determine if the user equipment is experiencing unfavourable signal conditions; and
if the user equipment is experiencing unfavourable signal conditions, reporting to the network only signal conditions relevant to maintaining a network connection for the user equipment.

30. The method according to claim 29, wherein evaluating measurements of signal conditions comprises comparing measurements of signal conditions against values associated with loss of service.

31. The method according to claim 30, wherein comparing measurements of signal conditions against values associated with loss of service comprises comparing at least one value against a minimum required quality level in a cell.

32. The method according to claim 31, wherein comparing the at least one value against the minimum required quality level in the cell comprises comparing signal chip power against the minimum required quality level in the cell, and determining that the user equipment is experiencing unfavourable signal conditions if the value of Ec/No is less than Qqualmin/2.

33. The method according to claim 29, wherein the measurements comprise measurements relating to the network connection for the user equipment and measurements relating to other signal conditions relating to the operation of the network.

34-42. (canceled)
